(19) United States
(12) Patent Application Publication
(10) Pub. No.: US 2020/0238966 A1
(43) Pub. Date: Jul. 30, 2020

(54) Bistable Solenoid Valve for a Hydraulic Braking System and Corresponding Hydraulic Braking System

(71) Applicant: Robert Bosch GmbH, Stuttgart (DE)

(72) Inventors: Massimiliano Ambrosi, Abstatt (DE); Edgar Kurz, Heilbronn-Horkheim (DE); Wolf Stahr, Abstatt (DE); Wolfgang Schuller, Cleebronn (DE); Michael Eisenlauer, Affalterbach (DE)

(21) Appl. No.: 16/609,820

(22) PCT Filed: Apr. 5, 2018
(86) PCT No.: PCT/EP2018/058699

§ 371 Date: Oct. 31, 2019

(30) Foreign Application Priority Data
May 29, 2017 (DE) 10 2017 208 938.5

(51) Int. Cl. B60T 15/02; F16K 31/06; F16K 31/08; B60T 13/68; B60T 13/62; B60T 8/40

(52) U.S. Cl. CPC B60T 15/028; F16K 31/0658; F16K 31/082; B60T 13/686; B60T 2270/404; B60T 8/4081; B60T 2270/402; B60T 2270/82; B60T 13/62

(57) ABSTRACT

A bistable solenoid valve for a hydraulic braking system includes a magnetic assembly and a guide sleeve in which a pole core is fixedly arranged and in which a valve armature is arranged for axial movement. The valve armature has a permanent magnet that is polarized in a direction of motion thereof. The magnetic assembly is slid onto the pole core and the guide sleeve, and the pole core forms an axial stop for the valve armature. The permanent magnet is injected or mounted in a magnet receptacle at an end face of the valve armature facing the pole core. The valve armature is configured to be driven by a magnetic force of the magnetic assembly and/or the permanent magnet so as to force a closing element into a valve seat during a closing motion and to lift the closing element out of the valve seat during an opening motion.

The invention is based on a bistable solenoid valve for a hydraulic braking system according to the definition of the species of independent patent claim 1. The subject matter of the present invention is also a hydraulic braking system for a vehicle having at least one such bistable solenoid valve.

Known hydraulic vehicle braking systems comprise a muscle-power-actuatable master cylinder, to which wheel brake cylinders of wheel brakes are hydraulically connected. The connection of the wheel brake cylinders is typically via a hydraulic unit, which comprises solenoid valves, hydraulic pumps, and hydraulic accumulators and enables a wheel-individual brake pressure regulation. Such brake pressure regulations enable the implementation of various safety systems, for example, antilock braking systems (ABS), electronic stability programs (ESP), etc., and the execution of various safety functions, for example, an antilock braking function, an anti-slip regulation (ASR), etc. Control and/or regulating procedures in the antilock braking system (ABS) or in the anti-slip regulation system (ASR system) or in the electronic stability program system (ESP system) for the pressure buildup or pressure dissipation in the corresponding wheel brakes can be carried out via the hydraulic unit. To carry out the control and/or regulating procedures, the hydraulic unit comprises solenoid valves, which can usually be held in unique positions as a result of the opposing forces “magnetic force”, “spring force”, and “hydraulic force”.

Moreover, designing hydraulic vehicle braking systems as power braking systems is known from the prior art, i.e., providing them with an external energy supply unit, which provides the energy required for service braking. The external energy supply unit typically comprises a hydraulic pressure accumulator, which is charged using a hydraulic pump. The muscle power exerted by the driver supplies a target value for the level of the braking force. An actuation of the vehicle braking system by the muscle power of the vehicle driver is only performed in an emergency mode as so-called auxiliary braking in the event of failure of the external energy supply unit. Assisted braking systems are also known, in which a part of the energy required for the brake actuation originates from an external energy supply unit and the other part originates from the muscle power of the vehicle driver. Both the power braking systems and also the assisted braking systems do not require a brake booster.

A hydraulic vehicle braking system having a muscle-power-actuatable master cylinder, to which wheel brake cylinders of wheel brakes are hydraulically connected, and having a hydraulic pressure source as an external energy supply unit, with which hydraulic pressure can be applied to the wheel brake cylinders for brake actuation, is known from DE 10 2008 001 013 A1. In this case, a pressure chamber of the master cylinder is connected via a decoupling valve to a brake fluid storage container, so that the pressure chamber can be switched to be depressurized. A brake actuation is performed as power braking using the external energy supply unit. Moreover, a hydraulic pedal travel simulator is integrated into the master cylinder, which is switchable to be depressurized via a simulator valve.

A bistable solenoid valve of the type in question is known from DE 33 05 833 A1, which comprises an exciter coil and an armature, which plunges therein and consists of permanent-magnetic material, is polarized in its movement direction, and forms a valve part. A magnetic field conducting body protrudes like a core into the exciter coil and fills up a part of the length of the exciter coil. A further magnetic field conducting body is arranged adjacent to the end of the exciter coil into which the armature plunges and is formed in the form of a ring disk, which encloses the armature with a spacing. If the exciter coil is deenergized, forces act between these magnetic field conducting bodies and the armature which move the armature into catch positions or at least fix it therein, and thus ensure stable switch positions of the solenoid valve. There is no requirement for a spring, which can move the valve part into a predetermined catch position, in this solenoid valve.

### DISCLOSURE OF THE INVENTION

The bistable solenoid valve for a hydraulic braking system having the features of independent patent claim 1 has the advantage that in a solenoid valve having a deenergized first operating state, a further deenergized second operating state can be implemented. This means that embodiments of the present invention provide a bistable solenoid valve which can be switched over between the two operating states by applying a switchover signal, wherein the solenoid valve remains permanently in the respective operating state until the next switchover signal. In this case, the first operating state can correspond to a closed position of the solenoid valve and the second operating state can correspond to an open position of the solenoid valve. The change between the two operating states can be carried out, for example, by briefly energizing the active actuator of the magnet assembly and/or by applying a switchover signal or current pulse to the magnet assembly. Using such brief energizing, the power consumption can advantageously be reduced in comparison to a conventional solenoid valve having two operating states, which only comprises one deenergized first operating state and has to be energized for the duration of the second operating state to implement the energized second operating state. Alternatively, the solenoid valve can be switched over from the open position into the closed position by briefly energizing the magnet assembly and then switched over from the closed position into the open position when a retaining pressure in the solenoid valve falls below a predetermined pressure threshold value.

A lighter valve armature than in the case of the conventional embodiment as a steel part can be provided by the embodiment as a plastic component. Moreover, the magnet receptacle and any arbitrary number of equalizing grooves can be integrated easily into the valve armature. The lighter valve armature and the permanent magnet arranged in the valve armature enable a reduction of the switching energy which has to be applied to switch the bistable solenoid valve between its states. The magnet assembly can thus be implemented having a shorter coil winding, so that the winding body and the housing jacket and also the guide sleeve and the valve armature can also be shortened and the complete installation space of the solenoid valve can be reduced. Due to the reduced installation length in the axial direction, more structural space is advantageously available for other assemblies and safety functions in the vehicle.

Embodiments of the present invention provide a bistable solenoid valve for a hydraulic braking system, having a magnet assembly and a guide sleeve, in which a pole core is arranged fixedly and a valve armature having a permanent magnet, which is polarized in its movement direction, is arranged axially displaceably. The magnet assembly is pushed onto the pole core and the guide sleeve. The pole core forms an axial stop for the valve armature. The valve armature is drivable by a magnetic force generated by the magnet assembly or by a magnetic force of the permanent magnet and pushes a closing element into a valve seat during a closing movement and raises the closing element off the valve seat during an opening movement. In this case, the valve armature is embodied as a plastic component and the permanent magnet is embedded or installed in a magnet receptacle on a first end face of the valve armature facing toward the pole core.

Moreover, a hydraulic braking system for a vehicle is proposed, having a hydraulic unit and multiple wheel brakes. The hydraulic unit comprises at least one brake circuit, which comprises at least one solenoid valve and carries out a wheel-individual brake pressure regulation. In this case, the at least one brake circuit comprises at least one bistable solenoid valve.

Embodiments of the bistable solenoid valve according to the invention can be used for normally open and for normally closed functions. The energizing of the magnet assembly can advantageously be briefly reversed in polarity via switches in the corresponding control unit. This opens up potential savings in a hydraulic braking system by unifying the valve types used and reducing the variety of variations of valve types in the construction kit for the hydraulic unit. In general and independently of the embodiment of the braking system, the use of a bistable solenoid valve instead of a permanently energized solenoid valve provides savings potential by reducing the electric power consumption. Moreover, the vehicle electrical system is relieved and the CO₂ emissions are reduced by the brief energizing of the magnet assembly. Furthermore, costly heating concepts in the electronic control unit of the braking system can be omitted. Moreover, fewer and/or smaller heatsinks, fewer heat resistant materials, and smaller spacings between the components in the control unit are possible, so that further structural space can advantageously be saved.

Advantageous improvements of the device specified in independent patent claim 1 and the method specified in independent patent claim 1 are possible by way of the measures and refinements set forth in the dependent claims.

It is particularly advantageous that the valve armature comprises at least two equalizing grooves and at least two ribs, which are each arranged between two adjacent equalizing grooves and partially enclose the permanent magnet. In this case, an end of the individual ribs partially enclosing the permanent magnet can be embodied in each case as a cover, in which the permanent magnet is embedded. Alternatively, an end of the individual ribs partially enclosing the permanent magnet can be embodied in each case as a catch hook, which can be locked with the permanent magnet. Moreover, the catch hooks can each comprise an insertion bevel, via which the permanent magnet can be installed. In one preferred embodiment, the valve armature comprises four equalizing grooves and four ribs, so that even at low temperatures, a rapid pressure equalization is possible in the air gap between the pole core and the valve armature and the switching time can be reduced. A cavity then also results between valve armature and pole core due to the covers and/or catch hooks formed between the pole core and the permanent magnet, when the valve armature presses against the pole core via the covers and/or catch hooks. A faster pressure equalization in the air gap between valve armature and pole core is enabled by this cavity between the valve armature and the pole core and the equalizing grooves, since a direct fluid connection is provided between the axial grooves of the armature and the end face of the armature or permanent magnet. An improvement of the closing time, in particular at low temperatures, can thus advantageously be achieved, by the so-called “hydraulic sticking” between the pole core and armature being reduced by the fluid connection, and also a buildup of a closing fluidic counterforce on the first end face of the armature being promoted by rapid propagation of the fluid. An additional contour is thus not required on the pole core to avoid the hydraulic sticking of the valve armature on the pole core and to effectuate better closing behavior and thus better closing dynamics at low temperatures. The hydraulic sticking results in particular due to adhesion forces, which act between smooth surfaces of the pole core and the first end face of the armature or the permanent magnet pressing against one another.

In a further advantageous embodiment of the bistable solenoid valve, the permanent magnet can be retained on the pole core in a deenergized open position of the solenoid valve, so that an air gap between pole core and valve armature is minimal and the closing element is raised off the valve seat.

In a further advantageous embodiment of the bistable solenoid valve, the magnet assembly can be energized using a first current direction during the closing movement, which generates a first magnetic field, which has the effect that the pole core repels the permanent magnet having the valve armature, so that the air gap between the valve armature and the pole core is enlarged and the closing element is pushed into the valve seat.

In a further advantageous embodiment of the bistable solenoid valve, a restoring spring can be arranged between the pole core and the valve armature. A spring force of the restoring spring can advantageously assist the closing movement. Moreover, in a deenergized closed position of the solenoid valve, a pressure confined in the solenoid valve and/or the restoring spring can hold the closing element in the valve seat to form a seal. Furthermore, the permanent magnet can move the valve armature in the direction of the pole core during the opening movement, so that the air gap between the valve armature and the pole core is reduced in size and the closing element is raised off the valve seat when the pressure confined in the solenoid valve falls below a pre-determinable limiting value. The effective spring force can be predetermined via the properties of the restoring spring so that the solenoid valve remains independent of the confined pressure in the closed position and the effective magnetic force of the permanent magnet is equalized. In an embodiment without restoring spring, a pressure limiting value can be predetermined via the properties of the permanent magnet and the resulting magnetic force, and if the pressure confined in the solenoid valve falls below this pressure limiting value, the valve armature moves from the closed position into the open position. Alternatively, the resulting magnetic force of the permanent magnet can be predetermined as sufficiently small that the valve armature with the closing element remains in the closed position independently of the confined pressure.

In a further advantageous embodiment of the bistable solenoid valve, the magnet assembly can be energized using a second current direction during the opening movement, which generates a second magnetic field, which causes the pole core and the permanent magnet having the valve armature to be attracted to one another, so that the air gap between the valve armature and the pole core is reduced in size and the closing element is raised off the valve seat. In this embodiment, the properties of the permanent magnet are selected so that the magnetic force of the permanent magnet is less than the active closing force, which the confined pressure and/or the restoring force generate.

In a further advantageous embodiment of the bistable solenoid valve, the permanent magnet can be arranged inside the magnet assembly independently of the armature stroke. The permanent magnet is thus always in the area of effect of the magnetic field generated by the magnet assembly upon energizing of the magnet assembly and can thus advantageously have smaller dimensions.

In an advantageous embodiment of the hydraulic braking system, the at least one bistable solenoid valve can release a brake pressure regulation in at least one associated wheel brake in the deenergized open position and can confine a present brake pressure in the at least one associated wheel brake in the deenergized closed position. An additional function can thus be implemented on a usually provided hydraulic unit having ESP functionality with little additional expenditure, which can electrohydraulically confine a present brake pressure in the corresponding wheel brake and retain it with little power consumption over a longer timeframe. This means that the existing pressure supply, the pipelines from the hydraulic unit to the wheel brakes, and sensor and communication signals can be used not only for the ESP function and/or ABS function and/or ASR function, but rather also for an electrohydraulic pressure retention function in the wheel brakes. Costs, structural space, weight, and wiring can thus advantageously be saved with the positive effect that the complexity of the braking system is reduced.

In a further advantageous embodiment of the hydraulic braking system, the at least one brake circuit can comprise a fluid pump, a suction valve, which connects a suction line of the fluid pump to a muscle-power-actuated master cylinder during a brake pressure regulation and disconnects the suction line of the fluid pump from the muscle-power-actuated master cylinder in the normal mode, and a switchover valve, which connects the muscle-power-actuated master cylinder to at least one associated wheel brake in the normal mode and retains the system pressure in the brake circuit during a brake pressure regulation. In this case, the switchover valve and/or the suction valve can be embodied as a bistable solenoid valve.

In an alternative embodiment of the hydraulic braking system, the at least one brake circuit can comprise a hydraulic pressure generator, the pressure of which is settable via a servo motor, a simulator valve, which connects a pedal simulator to a muscle-power-actuated master cylinder in the normal mode, and disconnects the pedal simulator from the master cylinder in the emergency mode and during a brake pressure regulation, a brake circuit disconnecting valve, which connects the muscle-power-actuated master cylinder to at least one associated wheel brake in the emergency mode and disconnects the muscle-power-actuated master cylinder from the at least one associated wheel brake in the normal mode and during a brake pressure regulation, and a pressure switching valve, which connects the hydraulic pressure generator to the at least one associated wheel brake in the normal mode and during a brake pressure regulation and disconnects the hydraulic pressure generator from the at least one associated wheel brake in the emergency mode. In this case, the simulator valve and/or the brake circuit disconnecting valve and/or the pressure switching valve can be embodied as a bistable solenoid valve.

Exemplary embodiments of the invention are illustrated in the drawing and are explained in greater detail in the following description. In the drawing, identical reference signs identify components or elements which execute identical or similar functions.

### BRIEF DESCRIPTION OF THE DRAWINGS

FIG. 1 shows a schematic sectional illustration of a first exemplary embodiment of a bistable solenoid valve according to the invention in the open position.

FIG. 2 shows a schematic sectional illustration of the bistable solenoid valve according to the invention from FIG. 1 in the closed position.

FIG. 3 shows a schematic sectional illustration of a detail of the bistable solenoid valve according to the invention from FIGS. 1 and 2 in the region of the magnet assembly during the closing movement.

FIG. 4 shows a schematic sectional illustration of the detail of the bistable solenoid valve according to the invention from FIG. 3 during the opening movement.

FIG. 5 shows a schematic sectional illustration of a second exemplary embodiment of a bistable solenoid valve according to the invention in the closed position.

FIG. 6 shows a schematic perspective illustration of an exemplary embodiment of a valve armature for the bistable solenoid valve according to the invention from FIG. 5.

FIG. 7 shows a schematic perspective partially sectional illustration of the valve armature from FIG. 6.

FIG. 8 shows a schematic perspective partially sectional illustration of a section of the valve armature from FIGS. 6 and 7 facing toward a pole core.

FIG. 9 shows a schematic perspective partially sectional illustration of a section of a further exemplary embodiment of a valve armature facing toward the pole core for the bistable solenoid valve according to the invention from FIG. 5.

FIG. 10 shows a schematic circuit diagram of a first exemplary embodiment of a hydraulic braking system according to the invention.

FIG. 11 shows a schematic circuit diagram of a second exemplary embodiment of a hydraulic braking system according to the invention.

### EMBODIMENTS OF THE INVENTION

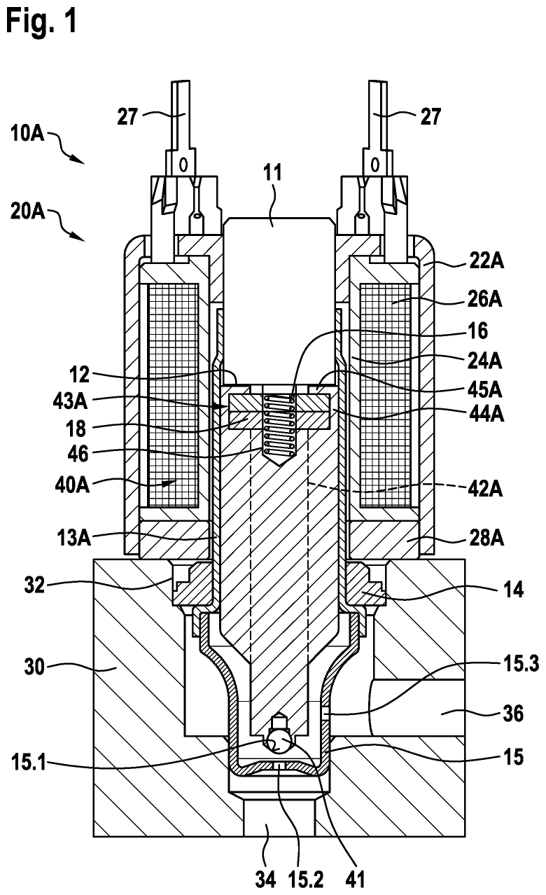

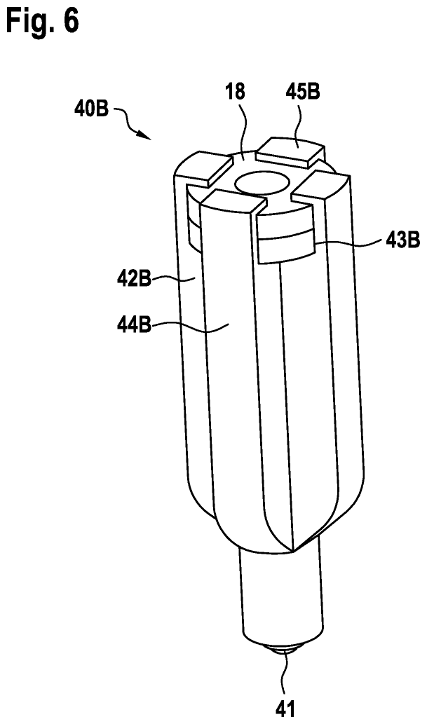

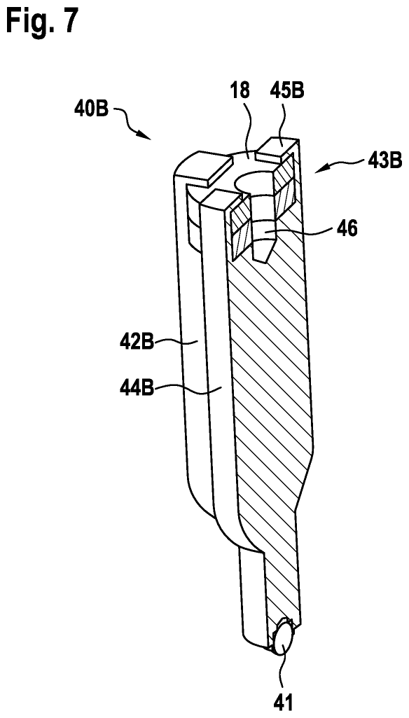

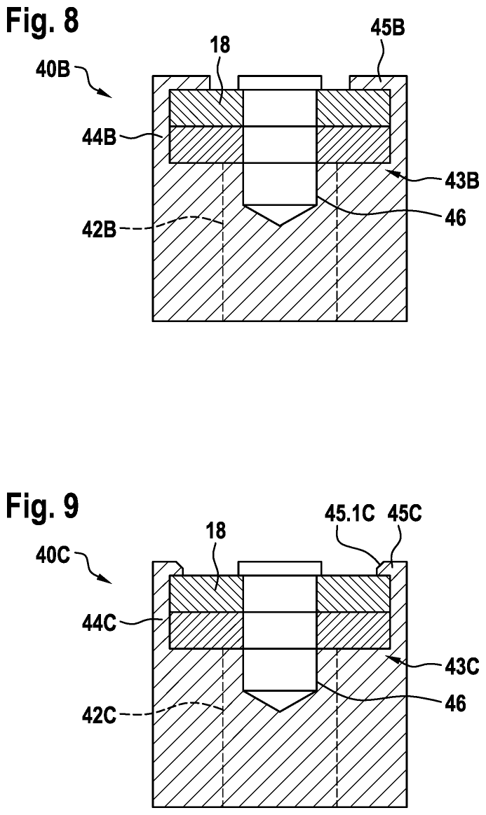

As is apparent from FIGS. 1 to 9, the illustrated exemplary embodiments of a bistable solenoid valve 10A, 10B according to the invention for a hydraulic braking system 1A, 1B each comprise a magnet assembly 20A, 20B and a guide sleeve 13, in which a pole core 11 is arranged fixedly and a valve armature 40A, 40B, 40C having a permanent magnet 18, which is polarized in its movement direction, is arranged axially displaceably. The magnet assembly 20A, 20B is pushed onto the pole core 11 and the guide sleeve 13. The pole core 11 forms an axial stop for the valve armature 40A, 40B, 40C. Moreover, the valve armature 40A, 40B, 40C is drivable by a magnetic force generated by the magnet assembly 20A, 20B and/or by a magnetic force of the permanent magnet 18 and pushes a closing element 41 into a valve seat 15.1 during a closing movement and raises the closing element 41 off the valve seat 15.1 during an opening movement. In this case, the valve armature 40A, 40B, 40C is embodied as a plastic component, wherein the permanent magnet 18 is embedded or installed in a magnet receptacle 43A, 43B, 43C on a first end face of the valve armature 40A, 40B, 40C facing toward the pole core 11.

As is furthermore apparent from FIGS. 1 to 9, the valve armatures 40A, 40B, 40C each have four at least two equalizing grooves 42A, 42B, 42C and at least two ribs 44A, 44B, 44C, which are each arranged between two adjacent equalizing grooves 42A, 42B, 42C and partially enclose the permanent magnet 18. In the illustrated exemplary embodiments, the valve armatures 40A, 40B, 40C each have four equalizing grooves 42A, 42B, 42C embodied as axial grooves and four ribs 44A, 44B, 44C. This enables a rapid pressure equalization in the air gap 12 between the pole core 11 and the valve armature 40A, 40B, 40C even at low temperatures, so that a reduced switching time results.

As is furthermore apparent from FIGS. 1 to 8, an end of the individual ribs 44A, 44B partially enclosing the permanent magnet 18 is respectively embodied as a cover 45A, 45B, in which the permanent magnet 18 is embedded, in the illustrated exemplary embodiments of the valve armature 40A, 40B. In these exemplary embodiments of the valve armature 40A, 40B, the permanent magnet is inserted, for example, in a plastic injection molding procedure as an insert part into a corresponding mold during the production of the valve armature 40A, 40B and is permanently bonded thereto during the production of the valve armature 40A, 40B.

As is furthermore apparent from FIG. 9, an end of the individual ribs 44C partially enclosing the permanent magnet 18 is respectively embodied as a catch hook 45C, which is locked with the permanent magnet 18, in the illustrated alternative exemplary embodiment of the valve armature 40C. The catch hooks 45 are extruded in the axial direction on the ribs 44C and each have an insertion bevel 45.1C, via which the permanent magnet 18 can be easily installed. During the installation of the permanent magnet 18, it is moved via the insertion bevels 45.1C and the catch hooks 45C move slightly outward until the permanent magnet 18 is seated in a final position. The catch hooks 45C then snap back into the starting positions thereof and securely hold the valve armature 40C in its operating position.

A cavity then also results between valve armature 40A, 40B, 40C and pole core 11 due to the covers 45A, 45B or catch hooks 45C formed between the pole core 11 and the permanent magnet 18 when the valve armature 40A, 40B, 40C presses against the pole core 11 in the open position via the covers 45A, 45B or the catch hooks 45C. Due to this cavity between the valve armature 11 and the pole core 11 and the equalizing grooves 42A, 42B, 42C, a faster pressure equalization is enabled in the air gap 12 between valve armature 40A, 40B, 40C and pole core 11, since a direct fluid connection is provided between the equalizing grooves 42A, 42B, 42C of the valve armature 40A, 40B, 40C and the end face of the valve armature 40A, 40B, 40C or the permanent magnet 18, respectively. An improvement of the closing time, in particular at low temperatures, can thus advantageously be achieved, by the so-called “hydraulic sticking” between the pole core 11 and the valve armature 40A, 40B, 40C being reduced by the fluid connection, and also a buildup of a closing fluidic counterforce on the first end face of the armature being promoted by rapid propagation of the fluid. Moreover, the covers 45A, 45B or catch hooks 45C act as damping elements, so that no damage to the permanent magnet 18 results due to the impact of the permanent magnet 18 on the pole core 11.

As is furthermore apparent from FIGS. 1 to 5, a hat-shaped valve sleeve 15 having a valve seat 15.1, which is arranged between at least one first flow opening 15.2 and at least one second flow opening 15.3, is connected to the guide sleeve 13. The solenoid valve 10A, 10B is caulked via a caulking disk 14 with a receptacle borehole of a fluid block 30, which comprises multiple fluid ducts 34, 36. As is furthermore apparent from FIGS. 1 to 5, a first flow opening 15.2, on the inner edge of which the valve seat 15.1 is formed, is introduced into a bottom of the hat-shaped valve sleeve 15 and fluidically connected to a first fluid duct 34. The at least one second flow opening 15.2 is introduced as a radial borehole into the lateral jacket surface of the hat-shaped valve sleeve 15 and is fluidically connected to a second fluid duct 36.

As is furthermore apparent from FIGS. 1 to 7, the closing element 41 is embodied as a ball in the illustrated exemplary embodiments and is pressed into a receptacle in the valve armature 40A, 40B, 40C, which is arranged on a second end face of the valve armature 40A, 40B, 40C facing toward the valve seat 15.1.

As is furthermore apparent from FIGS. 1 to 5, in each of the illustrated exemplary embodiments, the magnet assembly 20A, 20B comprises a hood-shaped housing jacket 22A, 22B, a winding body 24A, 24B, on which a coil winding 26A, 26B is applied, and a cover disk 28A, 28B, which terminates the hood-shaped housing jacket 22 on its open side. The coil winding 26A, 26B can be energized via two electrical contacts 27, which are led out of the housing jacket 22A, 22B. As is furthermore apparent from FIGS. 1 to 5, the permanent magnet 18 is arranged independently of the armature stroke inside the magnet assembly 20A, 20B.

As is furthermore apparent from FIGS. 1 to 5, in the illustrated exemplary embodiments of a bistable solenoid valve 10A, 10B, a restoring spring 16 is arranged between the pole core 11 and the valve armature 40A, 40B, 40C. In this case, a spring force of the restoring spring 16 can assist the closing movement of the valve armature 40A, 40B, 40C and/or the closing element 41. The valve behavior can be influenced via the selected spring force of the restoring spring 16, and a larger stroke or air gap 12 can also be bridged. As is furthermore apparent from FIGS. 1 to 5, in the illustrated exemplary embodiment, the restoring spring 16 is at least partially accommodated by a spring receptacle 46, which is introduced as a borehole into the valve armature 40A, 40B, 40C. As is furthermore apparent from FIGS. 1 to 9, the permanent magnet 18 is embodied in each of the illustrated exemplary embodiments as a circular perforated disk, which the restoring spring 16 penetrates. Alternatively, the permanent magnet 18 can be embodied as a polygonal perforated plate. In alternative exemplary embodiment (not shown), the spring receptacle 46 can be introduced as a borehole into the pole core 11. In this exemplary embodiment, the permanent magnet 18 can then be embodied as a disk or as a plate without holes. Moreover, both the pole core 11 and also the valve armature 40A, 40B, 40C can comprise a spring receptacle 19, which at least partially accommodate the restoring spring 16.

As is furthermore apparent from FIG. 1, the permanent magnet 18 holds itself in the illustrated deenergized open position of a first exemplary embodiment of the solenoid valve 10A on the pole core 11, so that an air gap 12 between pole core 11 and valve armature 40A is minimal and the closing element 41 is raised off the valve seat 15.1.

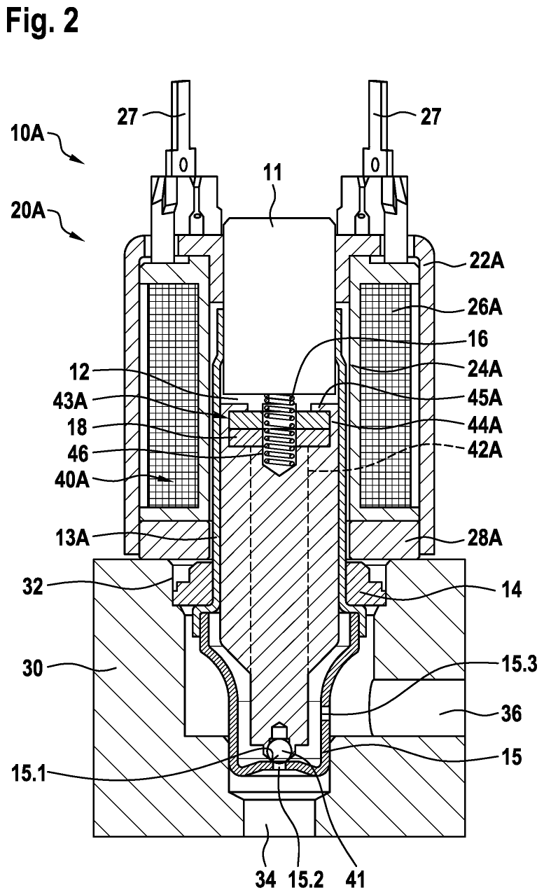

As is furthermore apparent from FIG. 2, in the illustrated first exemplary embodiment, a pressure confined in the solenoid valve 10A and the restoring spring 16 holds the closing element 41 in the valve seat 15.1 in the illustrated deenergized closed position to form a seal. In the illustrated exemplary embodiment, the magnetic force of the permanent magnet 18 is less than the acting closing force, which the confined pressure and/or the restoring spring 16 generate.

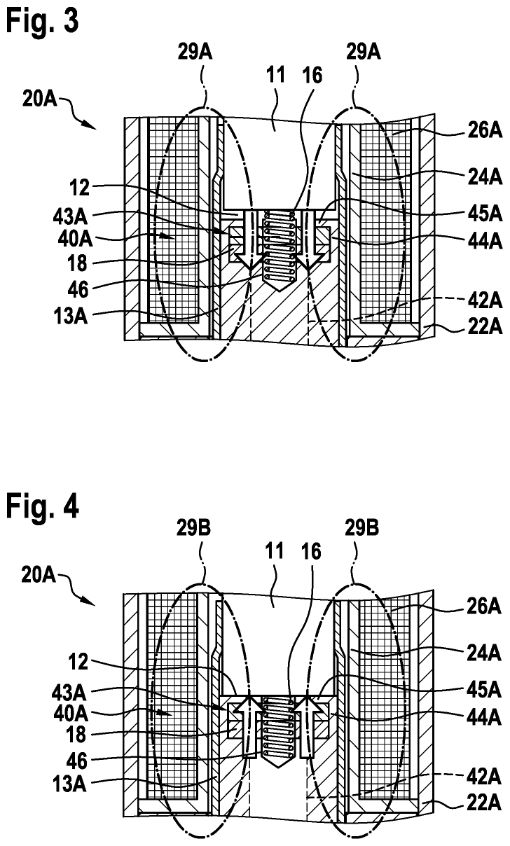

As is furthermore apparent from FIG. 3, the magnet assembly 20A is energized to close the solenoid valve 10A during the closing movement using a first current direction, which generates a first magnetic field 29A, which causes the pole core 11 to repel the permanent magnet 18 with the valve armature 40A, so that the air gap 12 between the valve armature 40A and the pole core 11 enlarges and the closing element 41 is pushed into the valve seat 15.1. Moreover, the spring force of the restoring spring 16 assists the closing movement of the valve armature 40A and/or the closing element 41.

As is furthermore apparent from FIG. 4, the magnet assembly 20A is energized to open the solenoid valve 10A during the opening movement using a second current direction, which generates a second magnetic field 29B, which causes the pole core 11 and the permanent magnet 18 with the valve armature 40A to attract one another, so that the air gap 12 between the valve armature 40A and the pole core 11 is reduced in size and the closing element 41 is raised off the valve seat 15.1. This means that the current flow through the magnet assembly 20A during the opening of the solenoid valve 10A is simply reversed in polarity in comparison to the closing of the solenoid valve 10A.

Alternatively, the magnetic force of the permanent magnet can be predetermined so that to open the solenoid valve 10A, the permanent magnet 18 moves the valve armature 40A in the direction of the pole core 11 during the opening movement if the pressure confined in the solenoid valve 10A sinks below a pre-determinable limiting value, so that the air gap 12 between the valve armature 40A and the pole core 11 is reduced in size and the closing element 41 is raised off the valve seat 15.1. In this embodiment, the solenoid valve 10A changes from the closed position into the open position without energizing of the magnet assembly 20A in dependence on the active hydraulic force and/or the confined pressure. This means that the magnetic force of the permanent magnet 18 is greater than the acting closing force, which the confined pressure and/or the restoring spring 16 generate if the confined pressure falls below the predetermined limiting value.

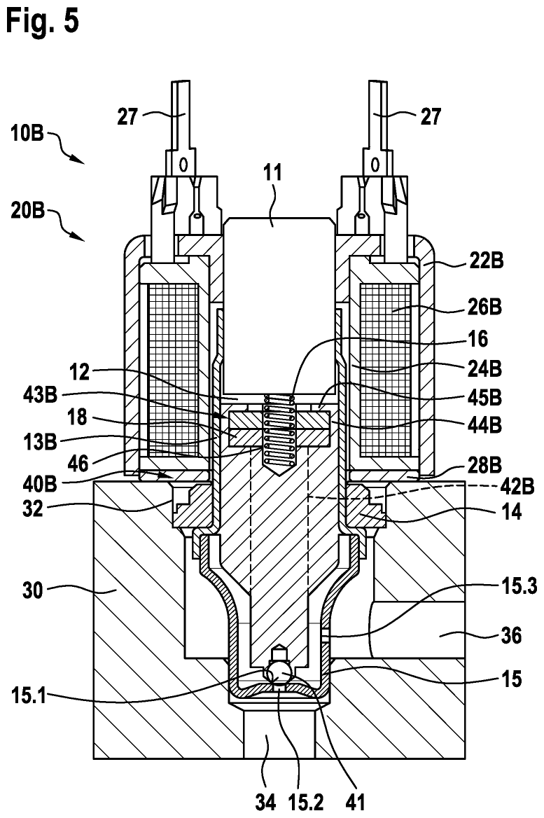

As is furthermore apparent from FIG. 5, an illustrated second exemplary embodiment of the solenoid valve 10B is embodied shorter than the first exemplary embodiment of the solenoid valve 10A with identical functionality. As is furthermore apparent from FIG. 5, in the illustrated second exemplary embodiment of the solenoid valve 10B, similarly to the first exemplary embodiment of the solenoid valve 10A, a pressure confined in the solenoid valve 10B and the restoring spring 16 retain the closing element 41 in the valve seat 15.1 in the illustrated deenergized closed position to form a seal. In the illustrated second exemplary embodiment, the magnetic force of the permanent magnet 18 is less than the acting closing force, which the confined pressure and/or the restoring spring 16 generate. As is furthermore apparent from FIG. 5, the magnet assembly 20B having the hood-shaped housing jacket 22B, the winding body 24B, the coil winding 26B, and the cover disk 28B is embodied shorter in the illustrated second exemplary embodiment of the solenoid valve 10B than the magnet assembly 20A of the first exemplary embodiment. The guide sleeve 13B and the valve armature 40B of the illustrated second exemplary embodiment of the solenoid valve 10B are also embodied shorter than the guide sleeve 13A and the valve armature 40A of the first exemplary embodiment of the solenoid valve 10A. The embodiment of the hat-shaped valve sleeve having the valve seat 15.1, the at least one first flow opening 15.2, and the at least one second flow opening 15.3 of the illustrated second exemplary embodiment corresponds to the embodiment of the valve sleeve 15 of the first exemplary embodiment of the solenoid valve 10A. The illustrated second exemplary embodiment corresponds to a compact cost-effective solenoid valve 10B, which requires a reduced installation space and less electrical power for switching.

In an alternative exemplary embodiment (not shown) of a bistable solenoid valve, in contrast to the illustrated exemplary embodiments of the bistable solenoid valve 10A, 10B, a restoring spring 16 is not arranged between the pole core 11 and the valve armature 40A, 40B, 40C. The permanent magnet 18 is then embodied in this exemplary embodiment as a circular disk or as a polygonal plate. Similarly to the illustrated exemplary embodiments, the permanent magnet 18 is retained on the pole core 11 in the deenergized open position of the exemplary embodiment (not shown) of the solenoid valve, so that the air gap 12 between pole core 11 and valve armature 40A, 40B, 40C is minimal and the closing element 41 is raised off the valve seat 15.1. For closing, the magnet assembly 20A, 20B of the solenoid valve (not shown) is energized during the closing movement using a first current direction, which generates the first magnetic field, which causes the pole core 11 to repel the permanent magnet 18 with the valve armature 40A, 40B, 40C, so that the air gap 12 between the valve armature 40A, 40B, 40C and the pole core 11 is enlarged and the closing element 41 is pushed into the valve seat 15.1. In contrast to the illustrated exemplary embodiments of the solenoid valve 10A, 10B, in the exemplary embodiment of the solenoid valve (not shown) only a pressure confined in the solenoid valve holds the closing element 41 in the valve seat 15.1 to form a seal. To open the solenoid valve, the magnet assembly 20A, 20B is energized during the opening movement using a second current direction, which generates a second magnetic field, which causes the pole core 11 and the permanent magnet 18 with the valve armature 40A, 40B, 40C to attract one another, so that the air gap 12 between the valve armature 40A, 40B, 40C and the pole core 11 is reduced in size and the closing element 41 is raised off the valve seat 15.1.

Alternatively, the magnetic force of the permanent magnet can be predetermined so that to open the solenoid valve, the permanent magnet 18 moves the valve armature 40A, 40B, 40C in the direction of the pole core 11 during the opening movement if the pressure confined in the solenoid valve sinks below a pre-determinable limiting value, so that the air gap 12 between the valve armature 40A, 40B, 40C and the pole core 11 is reduced in size and the closing element 41 is raised off the valve seat 15.1. In this embodiment, the solenoid valve changes from the closed position into the open position without energizing of the magnet assembly 20A, 20B in dependence on the active hydraulic force and/or on the confined pressure. This means that the magnetic force of the permanent magnet 18 is greater than the acting closing force which the confined pressure generates when the confined pressure falls below the predetermined limiting value.

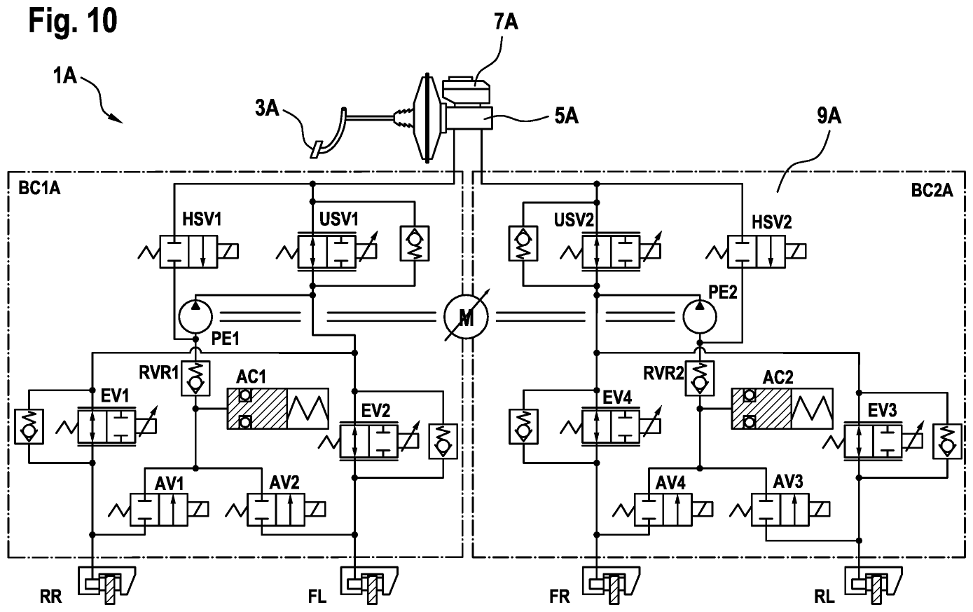

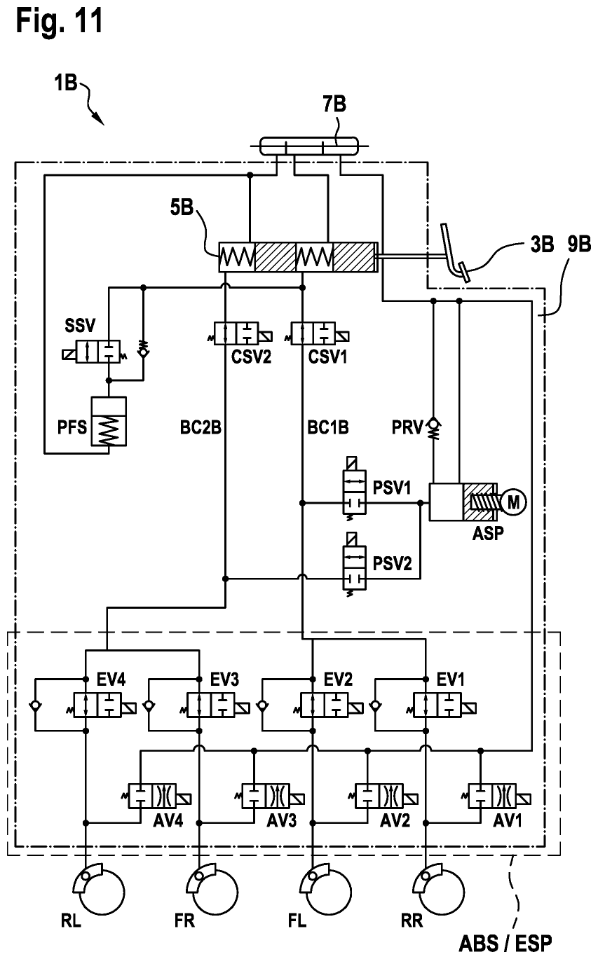

As is furthermore apparent from FIGS. 10 and 11, the illustrated exemplary embodiments of a hydraulic braking system 1A, 1B for a vehicle each comprise a hydraulic unit 9A, 9B and multiple wheel brakes RR, FL, FR, RL. The hydraulic unit 9A, 9B comprises at least one brake circuit BC1A, BC2A, BC1B, BC2B, which comprises at least one solenoid valve HSV1, HSV2, USV1, USV2, EV1, EV2, EV3, EV4, AV1, AV2, AV3, AV4, SSV, CSV1, CSV2, PSVT, PSV2, TSV and carries out a wheel-individual brake pressure regulation. In this case, the at least one brake circuit BC1A, BC2A, BC1B, BC2B comprises at least one bistable solenoid valve 10A, 10B.

As is apparent from FIGS. 10 and 11, the illustrated exemplary embodiments of a hydraulic braking system 1A, 1B according to the invention for a vehicle, using which various safety functions can be executed, each comprise a master cylinder 5A, 5B, a hydraulic unit 9A, 9B, and multiple wheel brakes RR, FL, FR, RL. As is furthermore apparent from FIGS. 10 and 11, the illustrated exemplary embodiments of the hydraulic braking system 1A, 1B each comprise two brake circuits BC1A, BC2A, BC1B, BC2B, which are each associated with two of the four wheel brakes RR, FL, FR, RL. Thus, a first wheel brake RR, which is arranged, for example, on a vehicle rear axle on the right side, and a second wheel brake FL, which is arranged, for example, on the vehicle front axle on the left side, are associated with a first brake circuit BC1A, BC1B. A third wheel brake FR, which is arranged, for example, on a vehicle front axle on the right side, and a fourth wheel brake RL, which is arranged, for example, on a vehicle rear axle on the left side, are associated with a second brake circuit BC2A, BC2B. Each wheel brake RR, FL, FR, RL is associated with an inlet valve EV1, EV2, EV3, EV4 and an outlet valve AV1, AV2, AV3, AV4, wherein pressure can be built up in the respective corresponding wheel brake RR, FL, FR, RL via the inlet valves EV1, EV2, EV3, EV4, and wherein pressure can be dissipated in the respective corresponding wheel brake RR, FL, FR, RL via the outlet valves AV1, AV2, AV3, AV4. For pressure buildup in the respective wheel brake RR, FL, FR, RL, the corresponding inlet valve EV1, EV2, EV3, EV4 is opened and the corresponding outlet valve AV1, AV2, AV3, AV4 is closed. For pressure dissipation in the respective wheel brake RR, FL, FR, RL, the corresponding inlet valve EV1, EV2, EV3, EV4 is closed and the corresponding outlet valve AV1, AV2, AV3, AV4 is opened.

As is furthermore apparent from FIGS. 10 and 11, a first inlet valve EV1 and a first outlet valve AV1 are associated with the first wheel brake RR, a second inlet valve EV2 and a second outlet valve AV2 are associated with the second wheel brake FL, a third inlet valve EV3 and a third outlet valve AV3 are associated with the third wheel brake FR, and a fourth inlet valve EV4 and a fourth outlet valve AV4 are associated with the fourth wheel brake RL. Control and/or regulating procedures for implementing safety functions can be carried out via the inlet valves EV1, EV2, EV3, EV4 and the outlet valves AV1, AV2, AV3, AV4.

As is furthermore apparent from FIG. 10, in the first exemplary embodiment of the hydraulic braking system 1A, the first brake circuit BC1A comprises a first suction valve HSV1, a first switchover valve USV1, a first compensation container AC1 having a first check valve RVR1, and a first fluid pump RFP1. The second brake circuit BC2A comprises a second suction valve HSV2, a second switchover valve USV2, a second compensation container AC2 having a second check valve RVR2, and a second fluid pump RFP2, wherein the first and second fluid pump RFP1, RFP2 are driven by a common electric motor M. Furthermore, the hydraulic unit 9A comprises sensor units (not shown) for ascertaining the present system pressure or brake pressure. The hydraulic unit 9A uses the first switchover valve USV1, the first suction valve HSV1, and the first recirculating pump RFP1 in the first brake circuit BC1A and the second switchover valve USV2, the second suction valve HSV2, and the second recirculating pump RFP2 in the second brake circuit BC2A for the brake pressure regulation and for implementing an ASR function and/or an ESP function. As is furthermore apparent from FIG. 10, each brake circuit BC1A, BC2A is connected to the master cylinder 5A, which can be actuated via a brake pedal 3A. Moreover, a fluid container 7A is connected to the master cylinder 5A. The suction valves HSV1, HSV2 enable an engagement in the braking system without a driver intention being present. For this purpose, the respective suction path for the corresponding fluid pump RFP1, RFP2 to the master cylinder 5A is opened via the suction valves HSV1, HSV2, so that it can provide the required pressure for the regulation instead of the driver. The switchover valves USV1, USV2 are arranged between the master cylinder 5A and at least one associated wheel brake RR, FL, FR, RL and set the system pressure or brake pressure in the associated brake circuit BC1A, BC2A. As is furthermore apparent from FIG. 10, a first switchover valve USV1 sets the system pressure or brake pressure in the first brake circuit BC1A and a second switchover valve USV2 sets the system pressure or brake pressure in the second brake circuit BC2A.

For this purpose, the at least two brake circuits BC1A, BC2A can each comprise a bistable solenoid valve 10A, 10B (not shown in greater detail), which has a deenergized closed position and a deenergized open position and is switchable between the two positions. Thus, for example, in each case a first bistable solenoid valve 10A, 10B can be looped into the respective brake circuit BC1A, BC2A in such a way that in the deenergized open position, it releases the brake pressure regulation in at least one associated wheel brake RR, FL, FR, RL and in the deenergized closed position, it confines a present brake pressure in the at least one associated wheel brake RR, FL, FR, RL. The first bistable solenoid valves 10A, 10B can be looped at various positions into the respective brake circuit BC1A, BC2A. Thus, the bistable solenoid valves 10A, 10B can be looped into the respective brake circuit BC1A, BC2A, for example, between the corresponding switchover valve USV1, USV2 and the inlet valves EV1, EV2, EV3, EV4 before an outlet duct of the corresponding fluid pump RFP1, RFP2. Alternatively, the bistable solenoid valves 10A, 10B can each be looped into the respective brake circuit BC1A, BC2A between the master cylinder 5A and the corresponding switchover valve USV1, USV2 directly before the corresponding switchover valve USV1, USV2. As a further alternative arrangement, the bistable solenoid valves 10A, 10B can each be looped into the respective brake circuit BC1A, BC2A between the corresponding switchover valve USV1, USV2 and the inlet valves EV1, EV2, EV3, EV4 after the outlet duct of the fluid pump RFP1, RFP2. Moreover, in a further alternative arrangement, the bistable solenoid valves 10A, 10B can each be looped into the respective brake circuit BC1A, BC2A between the master cylinder 5A and the corresponding switchover valve USV1, USV2 in the common fluid branch directly after the master cylinder 5A. Moreover, the bistable solenoid valves 10A, 10B can each be looped into the respective brake circuit BC1A, BC2A directly before an associated wheel brake RR, FL, FR, RL.

Moreover, in the illustrated exemplary embodiment, the two switchover valves USV1, USV2 and the two suction valves HSV1, HSV2 can each be embodied as a bistable solenoid valve 10A, 10B.

As is furthermore apparent from FIG. 11, the illustrated second exemplary embodiment of the hydraulic braking system 1B comprises, in contrast to the first exemplary embodiment, a hydraulic pressure generator ASP, the pressure of which can be set via a servo motor APM, and a pedal simulator PFS. The pressure generator ASP can be charged with fluid via a charging valve PRV from the fluid container 7B. As is furthermore apparent from FIG. 11, each brake circuit BC1B, BC2B is connected to the master cylinder 5B, which can be actuated via a brake pedal 3B. Moreover, a fluid container 7B is connected to the master cylinder 5B. Moreover, a chamber of the master cylinder 5B is coupled via a test valve TSV to the fluid container 7B. A simulator valve SSV connects the pedal simulator PFS to the muscle-power-actuated master cylinder 5B in normal operation and disconnects the pedal simulator PFS from the master cylinder 5B in the illustrated emergency mode and during a brake pressure regulation. The hydraulic unit 9B uses the hydraulic pressure generator ASP, and in the first brake circuit BC1B a first brake circuit disconnecting valve CSV1 and a first pressure switching valve PSV1, and in the second brake circuit BC2B a second brake circuit disconnecting valve CSV2 and a second pressure switching valve PSV2 for the brake pressure regulation and for implementing an ASR function and/or an ESP function. The pressure switching valves PSV1, PSV2 enable an engagement in the braking system without a driver intention being present. For this purpose, the pressure generator ASP is connected via the pressure switching valves PSV1, PSV2 to at least one associated wheel brake RR, FL, FR, RL, so that it can provide the required pressure for the regulation instead of the driver. As is furthermore apparent from FIG. 11, a first pressure switching valve PSV1 sets the system pressure or brake pressure in the first brake circuit BC1B and a second pressure switching valve PSV2 sets the system pressure or brake pressure in the second brake circuit BC2B. The brake circuit disconnecting valves CSV1, CSV2 connect the muscle-power-actuated master cylinder 5B to at least one associated wheel brake RR, FL, FR, RL in the illustrated emergency mode and disconnect the muscle-power-actuated master cylinder 5B from the at least one associated wheel brake RR, FL, FR, RL in the normal mode and during a brake pressure regulation. The pressure switching valves PSV1, PSV2 connect the hydraulic pressure generator ASP to the at least one associated wheel brake RR, FL, FR, RL in the normal mode and during a brake pressure regulation, and disconnect the hydraulic pressure generator ASP from the at least one associated wheel brake RR, FL, FR, RL in the emergency mode. Furthermore, the hydraulic unit 9B comprises multiple sensor units (not shown) for ascertaining the present system pressure or brake pressure. In the illustrated exemplary embodiment, the simulator valve SSV and the two pressure switching valves PSV1, PSV2 and one of the two brake circuit disconnecting valves CSV1, CSV2 are each embodied as bistable solenoid valves 10A, 10B. Since the present switching position is maintained in a bistable solenoid valve 10A, 10B in the event of failure of the vehicle electrical system and the bistable solenoid valves could also be deenergized closed at this moment, it is reasonable for the illustrated exemplary embodiment to replace only one of the two brake circuit disconnecting valves CSV1, CSV2 with a bistable solenoid valve 10A, 10B, so that in the event of a failure of the vehicle electrical system, the vehicle can be braked using one brake circuit BC1B, BC2B, since the conventional brake circuit disconnecting valve is embodied as a normally open solenoid valve and is held by its restoring spring in the open position.

In the illustrated hydraulic braking system 1B, the brake pressure in the normal driving mode is not conventionally generated by a vacuum brake booster assisted via the driver foot, but rather via the motor-operated pressure generator ASP. When the driver actuates the brake pedal 3B, this braking intention is sensed by the system via corresponding sensor units (not shown) and the simulator valve SSV and the pressure switching valves PSV1, PSV2 and the brake circuit disconnecting valves CSV1, CSV2 are switched simultaneously. The simulator valve SSV is switched over from the deenergized closed position into the deenergized open position. The driver thus displaces volume in the pedal simulator PFS and the driver receives haptic feedback about the braking procedure. The two brake circuit disconnecting valves CSV1, CSV2 are switched over from the deenergized open position into the deenergized closed position, whereby the brake lines from the master cylinder 5B are blocked. The pressure switching valves PSVT, PSV2 are switched over from the deenergized closed position into the deenergized open position, whereby the brake lines from the pressure generator ASP to the brake circuits BC1B, BC2B are opened and the pressure generator ASP can set the desired wheel-individual brake pressure.

1. A bistable solenoid valve for a hydraulic braking system, comprising:
a magnet assembly;
a guide sleeve;
a pole core fixedly arranged in the guide sleeve, the magnet assembly pushed onto the pole core and the guide sleeve; and
a valve armature axially displaceably arranged in the guide sleeve, the valve armature having a permanent magnet that is polarized in a movement direction thereof, the pole core defining an axial stop for the valve armature,
wherein the valve armature is configured to be driven by one or more of a magnetic force generated by the magnet assembly and a magnetic force of the permanent magnet and pushes a closing element into a valve seat during a closing movement and raises the closing element off the valve seat during an opening movement, and
wherein the valve armature is configured as a plastic component, and the permanent magnet is embedded or mounted in a magnet receptacle on a first end face of the valve armature facing toward the pole core.

2. The bistable solenoid valve as claimed in claim 1, wherein the valve armature comprises at least two equalizing grooves and at least two ribs, which are each arranged between two adjacent equalizing grooves and partially enclose the permanent magnet.

3. The bistable solenoid valve as claimed in claim 2, wherein an end of each of the ribs partially enclosing the permanent magnet is respectively configured as a cover, the permanent magnet embedded in the cover.

4. The bistable solenoid valve as claimed in claim 2, wherein an end of each of the ribs partially enclosing the permanent magnet is respectively configured as a catch hook, the catch hook locked with the permanent magnet.

5. The bistable solenoid valve as claimed in claim 4, wherein the catch hooks each comprise an insertion bevel via which the permanent magnet is installable.

6. The bistable solenoid valve as claimed in claim 1, wherein the permanent magnet is held on the pole core in a deenergized open position of the solenoid valve, so that an air gap between pole core and valve armature is minimal and the closing element is raised off the valve seat.

7. The bistable solenoid valve as claimed in claim 1, wherein the magnet assembly is energized during the closing movement in a first current direction, which generates a first magnetic field, which causes the pole core to repel the permanent magnet with the valve armature so that an air gap between the valve armature and the pole core is enlarged and the closing element is pushed into the valve seat.

8. The bistable solenoid valve as claimed in claim 1, wherein a restoring spring is arranged between the pole core and the valve armature, and wherein a spring force of the restoring spring assists the closing movement.

9. The bistable solenoid valve as claimed in claim 1, wherein, in a deenergized closed position of the solenoid valve, one or more of a pressure confined in the solenoid valve and a restoring spring arranged between the pole core and the valve armature hold the closing element in the valve seat to form a seal.

10. The bistable solenoid valve as claimed in claim 1, wherein the permanent magnet moves the valve armature in a direction of the pole core during the opening movement if a pressure confined in the solenoid valve falls below a pre-determinable limiting value so that an air gap between the valve armature and the pole core is reduced in size and the closing element is raised off the valve seat.

11. The bistable solenoid valve as claimed in claim 1, wherein the magnet assembly is energized during the opening movement in a second current direction, which generates a second magnetic field, which causes the pole core and the permanent magnet with the valve armature to attract one another so that an air gap between the valve armature and the pole core is reduced in size and the closing element is raised off the valve seat.

12. The bistable solenoid valve as claimed in claim 1, wherein the permanent magnet is arranged independently of a stroke of the valve armature within the magnet assembly.

13. A hydraulic braking system for a vehicle, comprising:
a hydraulic unit and a plurality of wheel brakes, the hydraulic unit including at least one brake circuit configured to carry out a wheel-individual brake pressure regulation,
wherein the at least one brake circuit includes at least one solenoid valve and at least one bistable solenoid valve, the bistable solenoid valve including:
a magnet assembly,
a guide sleeve,
a pole core fixedly arranged in the guide sleeve, the magnet assembly pushed onto the pole core and the guide sleeve, and
a valve armature axially displaceably arranged in the guide sleeve, the valve armature having a permanent magnet that is polarized in a movement direction thereof, the pole core defining an axial stop for the valve armature,
wherein the valve armature is configured to be driven by one or more of a magnetic force generated by the magnet assembly and a magnetic force of the permanent magnet and pushes a closing element into a valve seat during a closing movement and raises the closing element off the valve seat during an opening movement, and
wherein the valve armature is configured as a plastic component, and the permanent magnet is embedded or mounted in a magnet receptacle on a first end face of the valve armature facing toward the pole core.

14. The hydraulic braking system as claimed in claim 13, wherein the at least one bistable solenoid valve (i) releases a brake pressure regulation in at least one associated wheel brake in a deenergized open position and (ii) confines a present brake pressure in the at least one associated wheel brake in a deenergized closed position.

15. The hydraulic braking system as claimed in claim 13, wherein the at least one brake circuit comprises:
a fluid pump,
a suction valve, that connects a suction line of the fluid pump to a muscle-power-actuated master cylinder during a brake pressure regulation and disconnects the suction line of the fluid pump from the muscle-power-actuated master cylinder in a normal mode, and
a switchover valve that connects the muscle-power-actuated master cylinder to at least one associated wheel brake in the normal mode and retains the system pressure in the brake circuit during a brake pressure regulation.

16. The hydraulic braking system as claimed in claim 15, wherein one or more of the switchover valve and the suction valve are respectively configured as the bistable solenoid valve.

17. The hydraulic braking system as claimed in claim 13, wherein the at least one brake circuit comprises:
a hydraulic pressure generator, the pressure of which is configured to be set via a servo motor,
a simulator valve that connects a pedal simulator to a muscle-power-actuated master cylinder in a normal mode and disconnects the pedal simulator from the master cylinder in an emergency mode and during a brake pressure regulation,
a brake circuit disconnecting valve that connects the muscle-power-actuated master cylinder to at least one associated wheel brake in the emergency mode and disconnects the muscle-power-actuated master cylinder from the at least one associated wheel brake in the normal mode and during a brake pressure regulation, and
a pressure switching valve that connects the hydraulic pressure generator to the at least one associated wheel brake in the normal mode and during a brake pressure regulation and disconnects the hydraulic pressure generator from the at least one associated wheel brake in the emergency mode.

18. The hydraulic braking system as claimed in claim 17, wherein one or more of the simulator valve, the brake circuit disconnecting valve, and the pressure switching valve are respectively configured as the bistable solenoid valve.
